(19) United States
(12) Patent Application Publication
(10) Pub. No.: US 2026/0158921 A1
(43) Pub. Date: Jun. 11, 2026

(54) ADAPTIVE FILTER WITH Y CAPACITORS FOR A 3-PHASE DC ON-BOARD ELECTRICAL SYSTEM

(71) Applicant: VALEO EAUTOMOTIVE GERMANY GMBH, Erlangen (DE)

(72) Inventors: Alexander BUCHER, Erlangen (DE); Maximilian GERNER, Erlangen (DE); Guido RASEK, Erlangen (DE)

(73) Assignee: VALEO EAUTOMOTIVE GERMANY GMBH, Erlangen (DE)

(21) Appl. No.: 19/101,793

(22) PCT Filed: Jul. 6, 2023
(86) PCT No.: PCT/EP2023/068793

§ 371 Date: Feb. 6, 2025

(30) Foreign Application Priority Data
Aug. 15, 2022 (DE) 10 2022 120 544.4

(51) Int. Cl. B60L 3/00; B60L 15/00; B60L 53/22; H02M 1/44

(52) U.S. Cl. CPC B60L 3/003; B60L 15/007; B60L 53/22; H02M 1/44; B60L 2210/10; B60L 2210/46

(57) ABSTRACT

Power converter includes first, second and third lines, and a filter device. First to third terminals are connected to the first to third lines, and first and second capacitors form a central node connected to the third terminal. Third and fourth capacitors are connected between first capacitor and first terminal, and second capacitor and second terminal. A switching device switches between first and second filter modes, the first forming a first interference current path on the first line from the first terminal via the third capacitor, a parallel connection of the first and second capacitors and the central node to the third terminal, and a second interference current path on the second line from the second terminal via the fourth capacitor, a parallel connection of the first and second capacitors and the central node. In second filter mode interference currents along the current paths is reduced.

Power converter for an on-board electrical system of an electrically driveable vehicle, and on-board electrical system for an electrically driveable vehicle

The present invention relates to a power converter for an on-board electrical system of an electrically driveable vehicle, having a first line for a first potential, a second line for a second potential, a third line for a reference potential and a filter device having a first terminal connected to the first line, a second terminal connected to the second line, a third terminal connected to the third line, a first capacitor and a second capacitor, between which a central node with an electrically conductive connection to the third terminal is formed, and a switching device that is configured to switch between a first filter mode and a second filter mode of the filter device on the basis of control information.

In addition, the invention relates to an on-board electrical system for an electrically driveable vehicle.

DE 10 2017 220 982 A1 discloses a traction power supply system in an electric or hybrid vehicle. The traction power supply system comprises a high-voltage battery that is connected to a pulse-controlled inverter via a positive high-voltage line and a negative high-voltage line. A respective Y-capacitor is connected to the positive and the negative high-voltage line. The Y-capacitors are assigned a switching element that is able to be activated by a control unit on the basis of at least one operating state.

DE 10 2021 003 180 A1 discloses an on-board electrical system for an electrically operable vehicle, having a first electrical potential line and a second electrical potential line, between which a DC voltage is applied to the on-board electrical system. The on-board electrical system has two first interference suppression capacitors that are electrically connected in series and are each electrically coupled to the potential lines by way of a terminal. The on-board electrical system also has two further interference suppression capacitors and a switch.

In electrically driveable vehicles, on-board electrical systems, in particular high-voltage on-board electrical systems, are typically designed as an IT system in which a first and second potential of a traction battery are isolated from a reference potential, in particular a vehicle housing potential. Power converters that are used in such on-board electrical systems and the first and second line of which are able to be connected to the first and second potential of the traction battery may, during operation thereof, generate high-frequency interference signals that need to be filtered by way of a filter device for reasons of electromagnetic compatibility. Typically, such a filter device has two capacitors that are used in particular to dissipate a common-mode current on the first and the second line to a third line lying at the reference potential.

As the on-board electrical system voltage rises, this corresponding to the difference between the first potential and the second potential, the amount of energy stored in the first and second capacitor of the filter device also rises with the square of the on-board electrical system voltage. Relevant standards, such as for example ISO 6469-3, limit this amount of energy to a predefined value. As a result, in the case of an insulation fault, in particular during a charging process of the traction battery, electrical charges that are stored in the capacitors and flow away via the third line are able to be kept below a limit hazardous to the human body. Therefore, when designing power converters, an energy budget predefined by the design of the on-board electrical system has to be complied with.

It has indeed already been suggested to provide a switch in a current path between the capacitors and the third terminal in order to connect the capacitors to the third terminal of the filter device or the reference potential in a first filter mode and to disconnect them therefrom in a second filter mode. However, such switches have parasitic capacitances, the magnitude of which can be controlled only inaccurately due to production. In the second filter mode, this leads to a voltage division across the capacitors and the switch that can be predicted only with difficulty, which makes it much more difficult to precisely determine the energy budget for ensuring electrical safety and, possibly in conjunction with additional filter inductances, leads to a location of the filter frequencies that can be predicted very inaccurately.

The invention is based on the object of specifying an improved option for operating a power converter in an on-board electrical system of an electrically driveable vehicle.

According to the invention, this object is achieved in a power converter of the type mentioned at the outset in that the filter device also has a third capacitor, which is connected between a terminal of the first capacitor facing away from the central node and the first terminal of the filter device, and a fourth capacitor, which is connected between a terminal of the second capacitor facing away from the central node and the second terminal of the filter device, wherein in the first filter mode a first current path for an interference current is formed on the first line from the first terminal of the filter device via the third capacitor, a parallel connection of the first capacitor and of the second capacitor and the central node to the third terminal of the filter device, and a second current path for an interference current is formed on the second line from the second terminal of the filter device via the fourth capacitor, a parallel connection of the first capacitor and the second capacitor and the central node to the third terminal of the filter device, wherein in the second filter mode an admittance for the interference currents along the first current path and the second current path is at least reduced compared to the first filter mode.

The power converter according to the invention has a first line for a first potential, a second line for a second potential and a third line for a reference potential. The power converter further has a filter device. The filter device has a first terminal, a second terminal and a third terminal. The first terminal is connected to the first line. The second terminal is connected to the second line. The third terminal is connected to the third line. The filter device further has a first capacitor, a second capacitor, a third capacitor and a fourth capacitor. A central node with an electrically conductive connection to the third terminal is formed between the first capacitor and the second capacitor. The third capacitor is connected between a terminal of the first capacitor facing away from the central node and the first terminal of the filter device. The fourth capacitor is connected between a terminal of the second capacitor facing away from the central node and the second terminal of the filter device. The filter device furthermore has a switching device. The switching device is configured to switch between a first filter mode and a second filter mode of the filter device on the basis of control information. In the first filter mode, a first current path for an interference current is formed on the first line from the first terminal of the filter device via the third capacitor, a parallel connection of the first capacitor and the second capacitor and the central node to the third terminal of the filter device. In the first filter mode, a second current path for an interference current is also formed on the second line from the second terminal of the filter device via the fourth capacitor, a parallel connection of the first capacitor and the second capacitor and the central node to the third connection of the filter device. In the second filter mode, an admittance for the interference currents along the first current path and the second current path is at least reduced compared to the first filter mode.

In the power converter according to the invention, the first and second current paths in the first filter mode are routed via a parallel connection of the first capacitor and the second capacitor. This parallel connection advantageously forms a well-defined capacitance between the third capacitor and the fourth capacitor on the one hand and the third terminal on the other, which allows precise determination of an energy budget when designing the power converter. With an additional advantage, the capacitor network forms an X-capacitance in the first filter mode, which enables stronger suppression of opposed-mode interference. In the second filter mode, the effective Y-capacitances are substantially dominated by a series connection of the first capacitor and the third capacitor or by a series connection of the capacitances of the second capacitor and the fourth capacitor due to the reduction of the admittance. This enables a significant reduction of the Y-capacitances in the second filter mode, which places less strain on the energy budget and allows a more precise determination of an energy budget when designing the power converter compared to conventional filter devices.

The power converter according to the invention may be designed as an inverter, as a DC/DC voltage converter or as an active rectifier. The power converter according to the invention may furthermore have a housing in which at least the first line, the second line, the third line and the filter device are accommodated. The third line may be electrically conductively connected to the housing. In this respect, the reference potential may also be regarded as a housing potential.

The first potential typically differs from the second potential. Preferably, the first potential is greater than the second potential. The reference potential preferably lies between the first potential and the second potential. The reference potential may also be regarded as a ground potential. In one preferred configuration, the first line and the second line are each formed completely or at least in sections as solid busbars. The first and the second line may be connected to a DC voltage terminal of the power converter, at which in particular a connection device for putting the power converter in electrical contact with a DC voltage source is formed. The filter device is preferably arranged on the DC voltage terminal side. The interference currents are or contain common-mode currents in particular.

The third line is not necessarily formed as a busbar. The third line may be formed by a cable, a ground plane or by a fastening means by way of which the filter device is fastened in the power converter, in particular on the housing.

The first capacitor, the second capacitor, the third capacitor and the fourth capacitor may each have a first terminal and a second terminal between which the capacitance of the capacitor is provided. The first terminal of the third capacitor may be connected to the first terminal of the filter device. The second terminal of the fourth capacitor may be connected to the second terminal of the filter device.

The first capacitor, the second capacitor, the third capacitor and the fourth capacitor may each be formed by a capacitor component or a plurality of interconnected capacitor components. The switching device is preferably a semiconductor switching device that in particular has one or more transistor structures. As an alternative, it is also possible for the switching device to be an electromechanical switching device that has for example one or more relays.

Preferably, the filter device of the power converter according to the invention is set up to set a higher pole frequency and/or a lower effective total capacitance for filtering the interference currents in the second filter mode between the first terminal and the third terminal and between the second terminal and the third terminal than in the first filter mode. In the case of a first insulation fault, the discharge time constant, which results from the effectively active Y-capacitance and a discharge time constant resulting in body resistance, can thereby be advantageously modified.

In the power converter according to the invention, the admittance along the first current path between the third capacitor and the second capacitor can be at least reduced in the second filter mode compared to the first filter mode and the admittance along the second current path between the fourth capacitor and the first capacitor can be at least reduced compared to the first filter mode.

However, it is particularly preferred if, in the second filter mode, the first current path is interrupted in a circuit branch between the third capacitor and the second capacitor and the second current path is interrupted in a circuit branch between the fourth capacitor and the first capacitor. As a result, the Y-capacitances can be reduced particularly sharply in the second filter mode, as they are smaller than the lowest capacitance of the series connection in each case when the first capacitor and the third capacitor are connected in series on the one hand and when the second capacitor and the fourth capacitor are connected in series on the other.

In particular, in the second filter mode, a capacitance of a circuit branch connecting the first terminal and the central node can correspond to the reciprocal of the sum of the reciprocals of the capacitances of the first capacitor and the third capacitor, and a capacitance of a circuit branch connecting the second terminal and the central node can correspond to the reciprocal of the sum of the reciprocals of the capacitances of the second capacitor and the fourth capacitor.

In addition, in the first filter mode, a capacitance of a circuit branch connecting the third capacitor and the fourth capacitor on the one hand and the third terminal on the other hand can correspond to the sum of the capacitances of the first capacitor and the second capacitor.

In one preferred configuration of the power converter according to the invention, it is provided that the central node is a common node of the third terminal of the filter device, a terminal of the first capacitor facing away from the third capacitor and/or facing the second capacitor and a terminal of the second capacitor facing away from the fourth terminal and/or facing the first capacitor. The terminal of the first capacitor facing away from the third terminal and/or facing the second capacitor may correspond to the second terminal of the first capacitor. The terminal of the second capacitor facing away from the fourth terminal and/or facing the first capacitor may correspond to the first terminal of the second capacitor.

The first terminal of the first capacitor may be connected to the second terminal of the third capacitor. The second terminal of the second capacitor may be connected to the first terminal of the fourth capacitor.

The central node is preferably connected to the third terminal of the filter device.

In the power converter according to the invention, it is additionally preferred if the switching device has a first terminal and a second terminal and a switching path that can be controlled on the basis of the control information.

The first terminal of the switching device can have a common node with the first capacitor and the third capacitor. The second terminal of the third capacitor may be connected to the first terminal of the switching device. The first terminal of the first capacitor may be connected to the first terminal of the switching device.

Alternatively or additionally, the second terminal of the switching device has a common node with the second capacitor and the fourth capacitor. The second terminal of the second capacitor may be connected to the second terminal of the switching device. The first terminal of the fourth capacitor may be connected to the second terminal of the switching device.

In a preferred configuration, the switching device is configured to switch on the switching path so as to adopt the first filter mode and/or to switch it off so as to adopt the second filter mode.

With regard to the dimensioning of the capacitances of the power converter according to the invention, it is preferred if the capacitances of the first capacitor and the fourth capacitor are smaller than the capacitances of the second capacitor and the third capacitor, in particular by a factor of at least two, in particular by a factor of at least five. Alternatively, the capacitances of the first capacitor and the fourth capacitor can be greater than the capacitances of the second capacitor and the third capacitor, in particular by a factor of at least two, in particular by a factor of at least five.

The capacitances of the first capacitor and of the fourth capacitor may additionally be the same. The capacitances of the second capacitor and of the third capacitor may further be the same.

In order to also enable efficient suppression of opposed-mode interference in the second filter mode and to compensate for asymmetries in the event of different capacitance values, the filter device may furthermore have a fifth capacitor that is connected to the first terminal and to the second terminal of the filter device in parallel with the first to fourth capacitors. In other words, the fifth capacitor may provide a fixed X-capacitance. In particular, the fifth capacitor has a capacitance that is at least a factor of five, preferably a factor of ten, greater than the largest capacitance of the first to fourth capacitors.

In the power converter according to the invention, it may further be provided that a fourth terminal of the filter device is the first terminal of the filter device or is connected to the first line, a fifth terminal of the filter device is the second terminal of the filter device or is connected to the second line, and a sixth terminal of the filter device is the third terminal of the filter device or is connected to the third line. In a preferred development, it can be provided that the filter device further comprises a sixth capacitor and a seventh capacitor, between which a second central node is formed with an electrically conductive connection to the sixth terminal, an eighth capacitor, which is connected between a terminal of the sixth capacitor facing away from the second central node and the fourth terminal of the filter device, a ninth capacitor, which is connected between a terminal of the seventh capacitor facing away from the second central node and the fifth terminal of the filter device, and a second switching device, which is set up to switch between the first filter mode and the second filter mode of the filter device on the basis of the control information. It can also be provided that a third current path for the interference current is formed on the first line from the fourth terminal of the filter device via the eighth capacitor, a parallel connection of the sixth capacitor and the seventh capacitor and the second central node to the sixth terminal of the filter device, and a fourth current path for the interference current is formed on the second line from the fifth terminal of the filter device via the ninth capacitor, a parallel connection of the sixth capacitor and the seventh capacitor and the second central node to the sixth terminal of the filter device. In the second filter mode, an admittance for the interference currents along the third current path and the fourth current path can be at least reduced compared to the first filter mode. By providing the sixth to ninth capacitors, i.e. a second group of four capacitors connected in parallel to the first to fourth capacitors, further balancing of the current distribution within the filter device can be achieved.

In a preferred embodiment, it may be provided that the capacitances of the sixth capacitor and the ninth capacitor are greater than the capacitances of the seventh capacitor and the eighth capacitor, in particular by at least a factor of two, in particular by at least a factor of five, if the capacitances of the first capacitor and the fourth capacitor are smaller than the capacitances of the second capacitor and the third capacitor. Alternatively, it may be provided that the capacitances of the sixth capacitor and the ninth capacitor are smaller than the capacitances of the seventh capacitor and the eighth capacitor, in particular by a factor of at least two, in particular by a factor of at least five, if the capacitances of the first capacitor and the fourth capacitor are greater than the capacitances of the second capacitor and the third capacitor. The capacitance ratios in the second group can therefore be reversed in relation to the first group comprising the first to fourth capacitors. In particular, the capacitances of the first, fourth, seventh and eighth capacitors can be identical and/or the capacitances of the second, third, sixth and ninth capacitors can be identical.

In addition, all explanations regarding the first to fourth capacitors can be transferred to the sixth to ninth capacitors and all explanations regarding the first switching device can be transferred to the second switching device. The following may therefore apply in particular:

The sixth capacitor, the seventh capacitor, the eighth capacitor and the ninth capacitor may each have a first terminal and a second terminal between which the capacitance of the capacitor is provided. The first terminal of the eighth capacitor may be connected to the fourth terminal of the filter device. The second terminal of the ninth capacitor may be connected to the fifth terminal of the filter device.

The sixth capacitor, the seventh capacitor, the eighth capacitor and the ninth capacitor may each be formed by a capacitor component or a plurality of interconnected capacitor components. The second switching device is preferably a semiconductor switching device that in particular has one or more transistor structures. As an alternative, it is also possible for the second switching device to be an electromechanical switching device that has for example one or more relays.

Preferably, the filter device is set up to set a higher pole frequency and/or a lower effective total capacitance for filtering the interference currents in the second filter mode between the fourth terminal and the sixth terminal and between the fifth terminal and the sixth terminal than in the first filter mode.

In the second filter mode, the admittance along the third current path between the eighth capacitor and the seventh capacitor can be at least reduced compared to the first filter mode and the admittance along the fourth current path between the ninth capacitor and the sixth capacitor can be at least reduced compared to the first filter mode.

However, it is particularly preferred if, in the second filter mode, the third current path is interrupted in a circuit branch between the eighth capacitor and the seventh capacitor and the fourth current path is interrupted in a circuit branch between the ninth capacitor and the sixth capacitor.

In particular, in the second filter mode, a capacitance of a circuit branch connecting the fourth terminal and the second central node can correspond to the reciprocal of the sum of the reciprocals of the capacitances of the sixth capacitor and the eighth capacitor, and a capacitance of a circuit branch connecting the fifth terminal and the second central node can correspond to the reciprocal of the sum of the reciprocals of the capacitances of the seventh capacitor and the ninth capacitor.

In addition, in the first filter mode, a capacitance of a circuit branch connecting the eighth capacitor and the ninth capacitor on the one hand and the sixth terminal on the other hand can correspond to the sum of the capacitances of the sixth capacitor and the seventh capacitor.

In one preferred configuration, it is provided that the second central node is a common node of the sixth terminal of the filter device, a terminal of the sixth capacitor facing away from the eighth capacitor and/or facing the seventh capacitor and a terminal of the seventh capacitor facing away from the ninth terminal and/or facing the sixth capacitor. The terminal of the sixth capacitor facing away from the eighth terminal and/or facing the seventh capacitor may correspond to the second terminal of the sixth capacitor. The terminal of the seventh capacitor facing away from the ninth capacitor and/or facing the sixth capacitor may correspond to the first terminal of the seventh capacitor.

The first terminal of the sixth capacitor may be connected to the second terminal of the eighth capacitor. The second terminal of the seventh capacitor may be connected to the first terminal of the ninth capacitor.

The second central node is preferably connected to the sixth terminal of the filter device.

The second switching device can have a first terminal and a second terminal and a switching path able to be controlled depending on the control information.

The first terminal of the second switching device can have a common node with the sixth capacitor and the eighth capacitor. The second terminal of the eighth capacitor may be connected to the first terminal of the second switching device. The first terminal of the sixth capacitor may be connected to the first terminal of the second switching device.

Alternatively or additionally, the second terminal of the second switching device has a common node with the seventh capacitor and the ninth capacitor. The second terminal of the seventh capacitor may be connected to the second terminal of the second switching device. The first terminal of the ninth capacitor may be connected to the second terminal of the second switching device.

In a preferred configuration, the second switching device is configured to switch on the switching path so as to adopt the first filter mode and/or to switch it off so as to adopt the second filter mode.

In one preferred configuration of the power converter according to the invention, the filter device has a printed circuit board. The first to fourth capacitors may be arranged on the printed circuit board. The fifth capacitor may also be arranged on the printed circuit board. The sixth to ninth capacitors may also be arranged on the printed circuit board. The first to third terminals of the filter device may be arranged on the printed circuit board. The first switching device may be arranged on the printed circuit board. The second switching device may also be arranged on the printed circuit board.

The power converter according to the invention may furthermore have a DC link capacitor that is connected between the first line and the second line. The DC link capacitor can have a capacitance that is at least a factor of one hundred, preferably a factor of five hundred, greater than the largest capacitance of the first to fourth capacitor. The capacitance of the DC link capacitor is typically greater than the capacitance of the fifth capacitor, in particular by a factor of at least ten, preferably by a factor of at least fifty.

The power converter according to the invention may furthermore have a converter circuit that is connected between the first line and the second line. The converter circuit may have power semiconductor switches, which are interconnected in particular as a switching cell, power bridge or as a B6 bridge circuit, in order to convert the voltage present between the first line and the second line in a switching mode. The filter device is preferably arranged on that side of the DC link capacitor that faces away from the converter circuit.

The power converter according to the invention may furthermore have inductive filter elements that act as longitudinal inductances in the first line and the second line and are arranged on the DC link capacitor side and/or DC voltage input side of, in particular physically close to, the filter device. The filter elements may be formed around the lines by ferrite cores, for example nanocrystalline cores, iron powder cores or other cores made of magnetic material.

Parasitic inductances along the first line and the second lines between the DC voltage terminal, on the one hand, and the first terminal and the second terminal of the filter device or the filter elements on the DC voltage terminal side, on the other hand, are preferably lower than parasitic inductances between the first terminal and the second terminal of the filter device or the filter elements on the DC link capacitor side, on the one hand, and the DC link capacitor, on the other hand.

The object on which the invention is based is furthermore achieved by an on-board electrical system for an electrically driveable vehicle, having at least one power converter as described above, a traction battery, a charging device that is able to be connected to an electrical power supply system external to the vehicle in order to charge or discharge the traction battery, and a control device that is configured to provide the control information to adopt the second filter mode when and/or for as long as the charging device is connected to the electrical power supply system external to the vehicle.

It is thus advantageously possible to predefine the filter mode in a driving mode of the vehicle or of the on-board electrical system and the second filter mode in a charging mode.

The traction battery preferably has a nominal voltage of at least 400 volts, preferably at least 600 volts, particularly preferably at least 800 volts.

A power converter of the on-board electrical system may be designed as an inverter that is configured to supply electric power to an electric machine, in particular a permanently or electrically excited synchronous machine, an axial flux motor or an asynchronous machine, by way of a polyphase AC voltage in order to drive the vehicle.

A power converter of the on-board electrical system may form part of the charging device and may be configured to convert a DC or AC voltage provided by the electrical power supply system external to the vehicle into a DC voltage in order to charge the traction battery.

A power converter of the on-board electrical system may be designed as a DC/DC voltage converter that is configured to couple the on-board electrical system to a further on-board electrical system, in particular a low-voltage on-board electrical system, of the vehicle. A potential of the low-voltage on-board electrical system may correspond to the reference potential.

The on-board electrical system may furthermore have an electrical line, for example an electrically conductive fastening or a ground strip, by way of which the third line of the at least one power converter is electrically conductively connected to a vehicle body of the vehicle.

Further advantages and details of the present invention can be found in the exemplary embodiments described below and on the basis of the drawings. These drawings are schematic illustrations, in which:

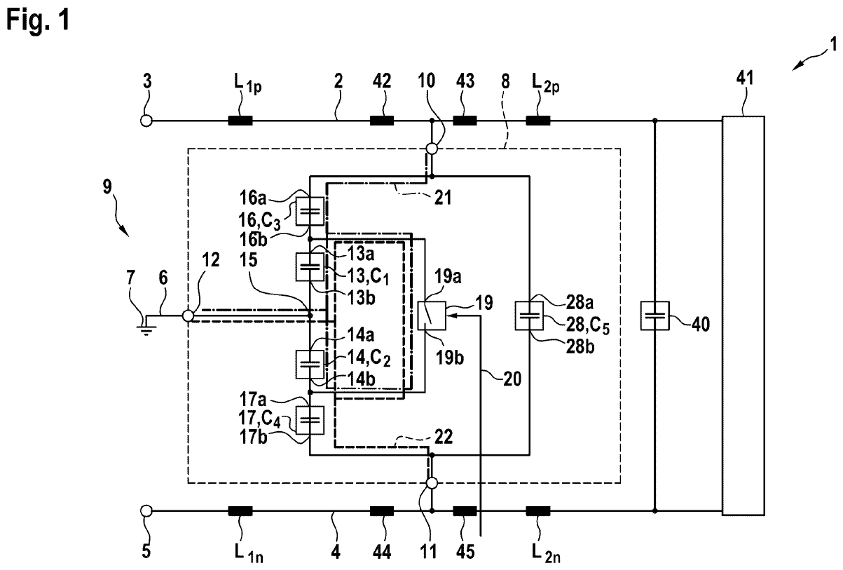

FIG. 1 shows a circuit diagram of one exemplary embodiment of the power converter according to the invention;

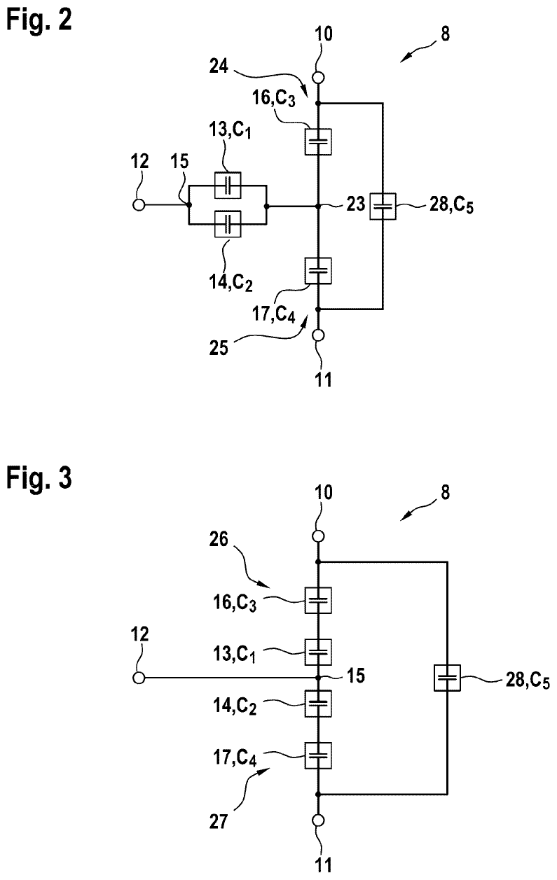

FIG. 2 shows an equivalent circuit diagram of the filter device in the first filter mode according to the exemplary embodiment;

FIG. 3 shows an equivalent circuit diagram of the filter device in the second filter mode according to the exemplary embodiment;

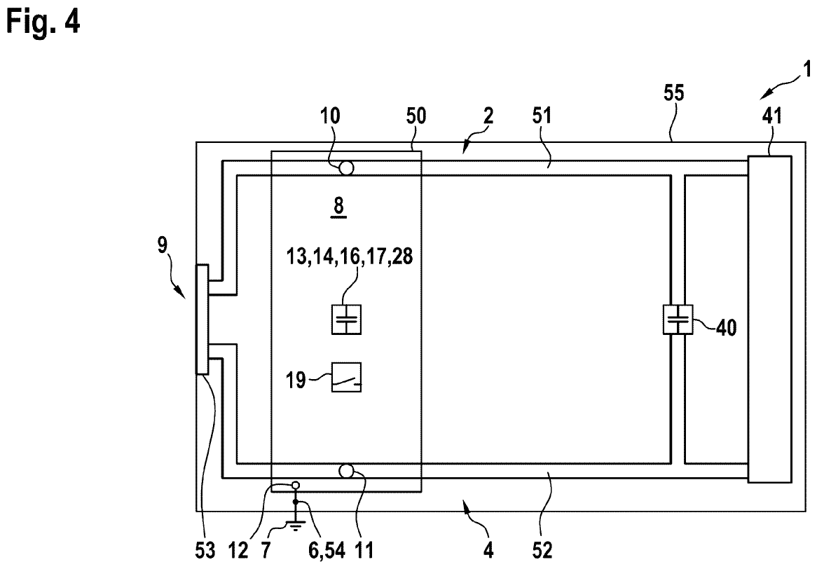

FIG. 4 shows a schematic diagram of the power converter according to the exemplary embodiment;

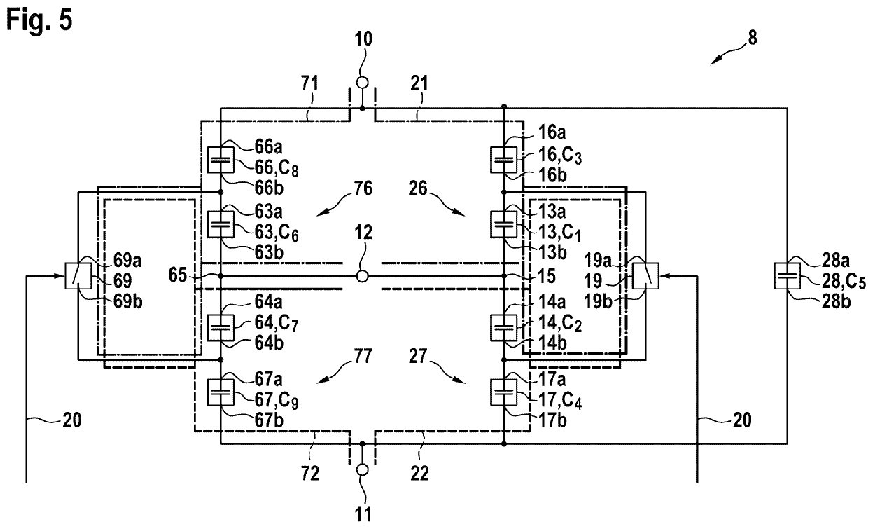

FIG. 5 shows a circuit diagram of the filter device according to a second exemplary embodiment of the power converter according to the invention;

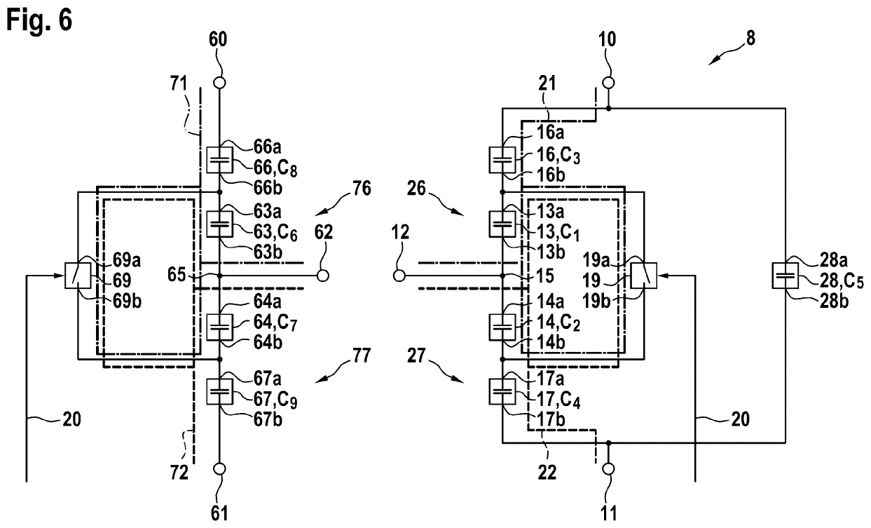

FIG. 6 shows a circuit diagram of the filter device according to a third exemplary embodiment of the power converter according to the invention; and

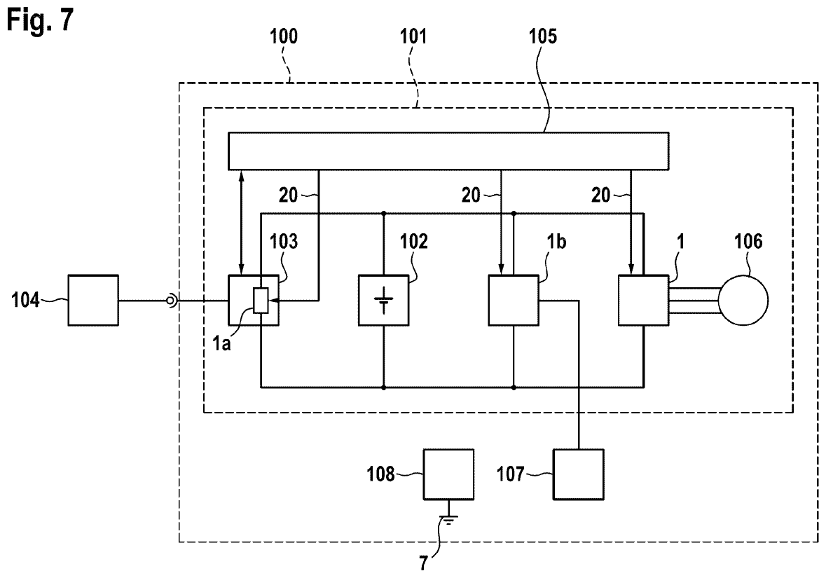

FIG. 7 shows a block diagram of one exemplary embodiment of the on-board electrical system according to the invention in a vehicle.

FIG. 1 is a circuit diagram of one exemplary embodiment of a power converter 1. The power converter 1 has a first line 2 for a first potential 3, a second line 4 for a second potential 5, and a third line 6 for a reference potential 7, which may also be considered as ground potential. By way of example, the first potential 3 is higher than the second potential 5 and the power converter 1 is configured to be operated with a potential difference of 800 volts between the first potential 3 and the second potential 5. The reference potential 7 lies, by way of example, between the first potential 3 and the second potential 5.

The power converter 1 also has a filter device 8. Specifically, the filter device 8 serves as an interference suppression filter, that is to say to improve the electromagnetic compatibility of the power converter 1, and is preferably arranged close to a DC voltage terminal 9.

The filter device 8 has a first terminal 10 that is connected to the first line 2, a second terminal 11 that is connected to the second line 4, and a third terminal 12 that is connected to the third line 6. In addition, the filter device has a first capacitor 13 and a second capacitor 14, between which a central node 15 is formed with an electrically conductive connection to the third terminal 12. The filter device 8 furthermore has a third capacitor 16 and a fourth capacitor 17. Here, first terminals of the capacitors 13, 14, 16, 17 are provided with the reference signs 13a, 14a, 16a, 17a and second terminals of the capacitors 13, 14, 16, 17 are provided with the reference signs 13b, 14b, 16b, 17b.

The third capacitor 16 is connected between the first terminal 13a, which faces away from the central node 15, of the first capacitor 13 and the first terminal 10 of the filter device 8. The fourth capacitor 17 is connected between the second terminal 14b, which faces away from the central node 15, of the second capacitor 14 and the second terminal 11 of the filter device 8.

In addition, the filter device 8 has a switching device 19. The switching device 19 is configured to switch between a first filter mode and a second filter mode on the basis of control information 20. In the first filter mode, a first current path 21 for an interference current is formed on the first line 2 from the first terminal 10, the third capacitor 16, a parallel connection of the first capacitor 13 and the second capacitor 14 as well as the central node 15 to the third terminal 12. In the first filter mode, a second current path 22 for an interference current is also formed on the second line 4 from the second terminal 11 via the fourth capacitor 17, the parallel connection of the first capacitor 13 and the second capacitor 14 and the central node 15 to the third terminal 12. In the second filter mode, an admittance for the interference currents along the first current path 21 and the second current path 22 is reduced compared to the first filter mode. The current paths 21, 22 are illustrated purely schematically by dashed lines in FIG. 1.

According to the present exemplary embodiment, the current paths 21, 22 are each partially interrupted in the second filter mode. The interruption of the first current path 21 is provided in a circuit branch between the third capacitor 16 and the second capacitor 14. The interruption of the second current path 22 is provided in a circuit branch between the fourth capacitor 17 and the first capacitor 13.

FIG. 2 and FIG. 3 are each an equivalent circuit diagram of the filter device 8, with FIG. 2 showing the first filter mode and FIG. 3 the second filter mode.

In the first filter mode, the first capacitor 13 and the second capacitor 14 are connected in parallel, so that the capacitance C₁ of the first capacitor 13 and the capacitance C₂ of the second capacitor 14 add up to a total capacitance between a circuit node 23, which is located between the third capacitor 16 and the fourth capacitor 17 in the equivalent circuit diagram, and the central node 15. The capacitance C₃ of the third capacitor 16 acts in a circuit branch 24 between the circuit node 23 and the first terminal 10 of the filter device 8. The capacitance C₄ of the fourth capacitor 17 acts in a circuit branch 25 between the circuit node 23 and the second terminal 11 of the filter device 8. The capacitor network thus formed in the first filter mode provides both a Y-capacitance for filtering common-mode interference and an X-capacitance for filtering opposed-mode interference.

In the second filter mode, the first capacitor 13 and the third capacitor 16 are connected in series in a circuit branch 26 between the first terminal 10 of the filter device 8 and the central node 15. Accordingly, in the second filter mode, the second capacitor 14 and the fourth capacitor 17 are also connected in series in a circuit branch 27 between the second terminal 11 of the filter device 8 and the central node 15. In the second filter mode, Y-capacitances thus act in circuit branches 26, 27, wherein the Y-capacitance in circuit branch 26 is the reciprocal of the sum of the reciprocals of C₁ and C₃ and in circuit branch 27 is the reciprocal of the sum of the reciprocal values of C₂ and C₄. This means that the Y-capacitance in each of the circuit branches 26, 27 is less than the lowest capacitance in the corresponding circuit branch 26, 27.

Again with reference to FIG. 1, the filter device 8 is realized in terms of circuitry in the present exemplary embodiment in particular in that the central node 15 is a common node of the third terminal 12 of the filter device 8, of the second terminal 13b of the first capacitor 13 facing away from the third capacitor 16 and towards the second capacitor 14, and of the first terminal 14a of the second capacitor 14 facing away from the fourth capacitor 17 and towards the first capacitor 13. The central node 15 is connected to the third terminal 12 of the filter device 8.

The switching device 19 has a first terminal 19a, a second terminal 19b and a switching path formed between the terminals 19a, 19b and controllable on the basis of the control information 20. The first terminal 19a of the switching device 19 has a common node with the first capacitor 13 and the third capacitor 16. The first terminal 19a of the switching device 19 is connected to the first terminal 13a of the first capacitor 13 and to the second terminal 16b of the third capacitor 16. The second terminal 19b of the switching device 19 has a common node with the second capacitor 14 and the fourth capacitor 17. The second terminal 19b of the switching device 19 is connected to the second terminal 14b of the second capacitor 14 and to the first terminal 17a of the fourth capacitor 17. The switching device 19 is configured to switch on the switching path so as to adopt the first filter mode and to switch it off so as to adopt the second filter mode.

In the present exemplary embodiment, the first terminal 16a of the third capacitor 16 is further connected to the first terminal 10 of the filter device 8. The second terminal 16b of the third capacitor 16 is connected to the first terminal 13a of the first capacitor 13. The second terminal 13b of the first capacitor 13 is connected to the first terminal 14a of the second capacitor and to the third terminal 12 of the filter device 8. The first terminal 14a of the second capacitor 14 is connected to the second terminal 13b of the first capacitor 13 and to the third terminal 12 of the filter device 8. The second terminal 14b of the second capacitor 14 is connected to the first terminal 17a of the fourth capacitor 17. The second terminal 17b of the fourth capacitor 17 is connected to the second terminal 11 of the filter device 8.

According to the present exemplary embodiment, a fifth capacitor 28 having a first terminal 28a and a second terminal 28b is further provided. The fifth capacitor 28 is connected to the first terminal 10 of the filter device 8 and to the second terminal 11 of the filter device 8 in parallel with the first to fourth capacitors 13, 14, 16, 17.

In this case, the first terminal 10 of the filter device 8, the first terminal 16a of the third capacitor 16 and the first terminal 28a of the fifth capacitor 28 form a common circuit node. Furthermore, the second terminal 11 of the filter device 8, the first terminal 17b of the fourth capacitor 17 and the second terminal 28b of the fifth capacitor 28 form a common circuit node. The fifth capacitor 28 provides a fixed X-capacitance.

In the present exemplary embodiment, the capacitances C₁ and C₄ are identical and smaller than the capacitances C₂ and C₃, which in turn are identical. The capacitance C₅ of the fifth capacitor 28 is in turn greater than the capacitances C₂ and C₃ . Example capacitance values are C₁=C₄=20 nF, C₂=C₃=100 nF, C5=1 μF. According to an alternative exemplary embodiment, the capacitances C₁ and C₄ are identical and larger than the capacitances C₂ and C₃, which in turn are identical. For example, in that case C₁=C₄=100 nF, C₂=C₃=20 nF, C5=1 μF.

FIG. 1 furthermore shows a DC link capacitor 40 that is connected between the first line 2 and the second line 4 and the capacitance of which is at least 50 μF, and a converter circuit 41 that is connected between the first line 2 and the second line 4. It may be seen that the filter device 8 is arranged on that side of the DC link capacitor 40 that faces away from the converter circuit 41.

The power converter 1 furthermore has four inductive filter elements 42, 43, 44, 45, which act as longitudinal inductances in the lines 2, 4 and are formed around the lines 2, 4, for example by ferrite cores, such as nanocrystalline cores, iron powder cores or other cores made of magnetic material. The filter elements 42 to 45 are arranged close to the filter device 8. The filter elements 42, 44 are arranged on the DC voltage input side with respect to the filter device 8. The filter elements 43, 45 are arranged on the DC link capacitor side with respect to the filter device 8.

FIG. 1 furthermore schematically illustrates parasitic inductances Lip, Lin along the first line 2 and the second line 4, respectively, between the DC voltage terminal 9 and the filter device 8 and the filter elements 42, 44, respectively, and parasitic inductances L₂ₚ, L₂ₙ along the first line 2 and the second line 4, respectively, between the filter device 8 and the filter elements 43, 45, respectively, and the DC link capacitor 40. In this case, the arrangement of the filter device 8 is preferably selected such that Lip and Lin are less than L₂ₚ and L₂ₙ, in order to enable filtering that is as efficient as possible.

FIG. 4 is a schematic diagram of the power converter 1 according to the exemplary embodiment.

The filter device 8 has a printed circuit board 50 on which the terminals 10, 11, 12, the capacitors 13, 14, 16, 17, 28 and the switching device 19 are arranged. The first line 2 and the second line 4 are each formed by solid busbars 51, 52 that are in contact with the terminals 10, 11 on the printed circuit board 50. The DC voltage terminal 9, formed as a connection device 53, is connected to a first end of the busbars 51, 52. The converter circuit 41 is connected to a second end of the busbars 51, 52. The DC link capacitor 40 is likewise in contact with the busbars 51, 52 and is located, in relation to the length of the busbars 51, closer to the converter circuit 41 than to the filter device 8.

The third terminal 12 of the filter device 8 is not in contact with the busbars 51, 52, but rather is connected to a housing 55 of the power converter 1 by way of a fastening means 54 that forms the third line 6. The reference potential 7 may therefore also be regarded as a housing potential. The lines 2, 4 or the busbars 51, 52, the filter device 8, the DC link capacitor 40 and the converter circuit 41 are housed in the housing 55.

The power converter 1 may be designed as an inverter, a DC/DC voltage converter or as an active rectifier. The converter circuit 41 has semiconductor switching elements suitable for this purpose.

FIG. 5 is a circuit diagram of the filter device 8 according to a second exemplary embodiment of the power converter 1. All details for the first exemplary embodiment can be transferred to the second exemplary embodiment, unless otherwise described below. Identical or functionally equivalent components are provided with identical reference signs.

According to the second exemplary embodiment, the filter device 8 additionally has a sixth capacitor 63 and a seventh capacitor 64, between which a second central node 65 is formed with an electrically conductive connection to the third terminal 12. The filter device 8 furthermore has an eighth capacitor 66 and a ninth capacitor 67. Here, first terminals of the capacitors 63, 64, 66, 67 are provided with the reference signs 63a, 64a, 66a, 67a and second terminals of the capacitors 63, 64, 66, 67 are provided with the reference signs 63b, 64b, 66b, 67b.

The eighth capacitor 66 is connected between the first terminal 63a, which faces away from the second central node 65, of the sixth capacitor 63 and the first terminal 10 of the filter device 8. The ninth capacitor 67 is connected between the second terminal 64b, which faces away from the second central node 65, of the seventh capacitor 64 and the second terminal 11 of the filter device 8.

In addition, the filter device 8 has a second switching device 69. The second switching device 69 is configured to switch between the first filter mode and the second filter mode on the basis of control information 20. In the first filter mode, a third current path 71 for the interference current is formed on the first line 2 from the first terminal 10, the eighth capacitor 66, a parallel connection of the sixth capacitor 63 and the seventh capacitor 64 as well as the second central node 65 to the third terminal 12. In the first filter mode, a fourth current path 72 for the interference current is also formed on the second line 4 from the second terminal 11 via the ninth capacitor 67, the parallel connection of the sixth capacitor 63 and the seventh capacitor 64 and the second central node 65 to the third terminal 12. In the second filter mode, an admittance for the interference currents along the third current path 71 and the fourth current path 72 is reduced compared to the first filter mode. The current paths 21, 22, 71, 72 are illustrated purely schematically by dashed lines in FIG. 5.

According to the second exemplary embodiment, the current paths 71, 72 are each partially interrupted in the second filter mode. The interruption of the third current path 71 is provided in a circuit branch between the eighth capacitor 66 and the seventh capacitor 64. The interruption of the fourth current path 72 is provided in a circuit branch between the ninth capacitor 67 and the sixth capacitor 63.

In the first filter mode, the sixth capacitor 63 and the seventh capacitor 64 are connected in parallel, so that the capacitance C₆ of the sixth capacitor 63 and the capacitance C₇ of the seventh capacitor 64 add up to a total capacitance between a circuit node which, analogous to the circuit node 23 in the equivalent circuit diagram according to FIG. 2 between the eighth capacitor 66 and the ninth capacitor 67, and the second central node 65. The capacitance C₈ of the eighth capacitor 66 acts in a circuit branch, which corresponds to the circuit branch 24 according to FIG. 2, between the circuit node corresponding to the circuit node 23 and the first terminal 10 of the filter device 8. The capacitance C₉ of the ninth capacitor 67 acts in a circuit branch, which corresponds to the circuit branch 25 according to FIG. 2, between the circuit node corresponding to the circuit node 23 and the second terminal 11 of the filter device 8. The capacitor network thus formed in the first filter mode from the sixth to ninth capacitors 63, 64, 66, 67 provides both a Y-capacitance for filtering common-mode interference and an X-capacitance for filtering opposed-mode interference.

In the second filter mode, the sixth capacitor 63 and the eighth capacitor 66 are connected in series in a circuit branch 76 between the first terminal 10 of the filter device 8 and the second central node 65. Accordingly, in the second filter mode, the seventh capacitor 64 and the ninth capacitor 67 are also connected in series in a circuit branch 77 between the second terminal 11 of the filter device 8 and the second central node 65. In the second filter mode, Y-capacitances thus act in circuit branches 76, 77, wherein the Y-capacitance in circuit branch 76 is the reciprocal of the sum of the reciprocals of C₆ and C₈ and in circuit branch 77 is the reciprocal of the sum of the reciprocal values of C₇ and C₉. This means that the Y-capacitance in each of the circuit branches 76, 77 is less than the lowest capacitance in the corresponding circuit branch 76, 77.

The second central node 65 is a common node of the third terminal 12 of the filter device 8, the second terminal 63b of the sixth capacitor 63 facing away from the eighth capacitor 66 and towards the seventh capacitor 64 and the first terminal 64a of the seventh capacitor 64 facing away from the ninth capacitor 67 and towards the sixth capacitor 63. The second central node 65 is connected to the third terminal 12 of the filter device 8.

The second switching device 69 has a first terminal 69a, a second terminal 69b and a switching path formed between the terminals 69a, 69b and controllable on the basis of the control information 20. The first terminal 69a of the switching device 69 has a common node with the sixth capacitor 63 and the eighth capacitor 66. The first terminal 69a of the second switching device 69 is connected to the first terminal 63a of the sixth capacitor 63 and to the second terminal 66b of the eighth capacitor 66. The second terminal 69b of the second switching device 69 has a common node with the seventh capacitor 64 and the ninth capacitor 67. The second terminal 69b of the second switching device 69 is connected to the second terminal 64b of the seventh capacitor 64 and to the first terminal 67a of the ninth capacitor 67. The second switching device 69 is configured to switch on the switching path so as to adopt the first filter mode and to switch it off so as to adopt the second filter mode.

The first terminal 66a of the eighth capacitor 66 is connected to the first terminal 10 of the filter device 8. The second terminal 66b of the eighth capacitor 66 is connected to the first terminal 53a of the sixth capacitor 63. The second terminal 63b of the sixth capacitor 63 is connected to the first terminal 64a of the seventh capacitor 64 and to the third terminal 12 of the filter device 8. The first terminal 64aof the seventh capacitor 64 is connected to the second terminal 63b of the sixth capacitor 63 and to the third terminal 12 of the filter device 8. The second terminal 64b of the seventh capacitor 64 is connected to the first terminal 67a of the ninth capacitor 67. The second terminal 67b of the ninth capacitor 67 is connected to the second terminal 11 of the filter device 8.

In the present exemplary embodiment, the capacitances C₆ and C₉ are identical and the capacitances C₇ and C₈ are identical. If the capacitances C₁, C₄ are greater than the capacitances C₂, C₃ the capacitances C₆, C₉ are smaller than the capacitances C₇, C₈. If the capacitances C₁, C₄ are smaller than the capacitances C₂, C₃ the capacitances C₆, C₉ are greater than the capacitances C₇, C₈. In particular, the capacitances C₁, C₄, C₇ and C₈ are are identical and the capacitances C₂, C₃, C₆, C₉ are identical.

In the second exemplary embodiment, the sixth to ninth capacitors 63, 64, 66, 67 and the second switching device 69 are also arranged on the printed circuit board 50 (see FIG. 4).

FIG. 6 shows a circuit diagram of the filter device 8 according to a third exemplary embodiment of the power converter 1, which corresponds to the second exemplary embodiment except for the following differences.

According to the third exemplary embodiment, the filter device 8 additionally has a fourth terminal 60, which is connected to the first line 2, a fifth terminal 61, which is connected to the second line 4, and a sixth terminal 62, which is connected to the third line 6. In this case, the following is envisaged:

The second central node 65 has an electrically conductive connection to the sixth connection 12 of the filter device 8. The eighth capacitor 66 is connected between the first terminal 63a of the sixth capacitor 63 and the fourth terminal 60 of the filter device 8. The ninth capacitor 67 is connected between the second terminal 64b of the seventh capacitor 64 and the fifth terminal 61 of the filter device 8. The third current path 71 runs from the fourth terminal 60 via the eighth capacitor 66, the parallel connection of the sixth capacitor 63 and the seventh capacitor 64 and the second central node 65 to the sixth terminal 62. The fourth current path 72 runs from the fifth terminal 61 via the ninth capacitor 67, the parallel connection of the sixth capacitor 63 and the seventh capacitor 64 and the second central node 65 to the sixth terminal 62.

In the first filter mode, the capacitance C& acts in a circuit branch, which corresponds to the circuit branch 24 according to FIG. 2, between the circuit node corresponding to the circuit node 23 and the fourth terminal 60. The capacitance C₉ in a circuit branch, which corresponds to the circuit branch 25 according to FIG. 2, between the circuit node corresponding to the circuit node 23 and the fifth terminal 61. In the second filter mode, the sixth capacitor 63 and the eighth capacitor 66 are connected in series in a circuit branch 76 between the fourth terminal 10 and the second central node 65, and the seventh capacitor 64 and the ninth capacitor 67 are connected in series in a circuit branch 77 between the fifth terminal 61 and the second central node 65.

The second central node 65 is a common node of the sixth terminal 62, the second terminal 63b of the sixth capacitor 63 and the first terminal 64a of the seventh capacitor 64. The second central node 65 is connected to the second terminal 62.

The first terminal 66a of the eighth capacitor 66 is connected to the fourth terminal 60 of the filter device 8. The second terminal 66b of the eighth capacitor 66 is connected to the first terminal 63a of the sixth capacitor 63. The second terminal 63b of the sixth capacitor 63 is connected to the first terminal 64a of the seventh capacitor 64 and to the sixth terminal 62. The first terminal 64a of the seventh capacitor 64 is connected to the second terminal 63b of the sixth capacitor 63 and to the sixth terminal 62. The second terminal 64b of the seventh capacitor 64 is connected to the first terminal 67a of the ninth capacitor 67. The second terminal 67b of the ninth capacitor 67 is connected to the fifth terminal 61.

In the third exemplary embodiment, all capacitors 13, 14, 16, 17, 28, 63, 64, 66, 67 and the switching devices 19, 69 together with the terminals 10, 11, 12, 60, 61, 62 can be arranged on the printed circuit board 50 (see FIG. 4). Alternatively, it is also possible for the sixth to ninth capacitors 63, 64, 66, 67, the second switching device 69 and the fourth to sixth terminals 60, 61, 62 to be arranged on an additional printed circuit board (not shown).

Moreover, the second and third exemplary embodiments can also be combined in such a way that only some of the terminals 60, 61, 62 are designed as separate terminals and some of the terminals are identical to the terminals 10, 11, 12. For example, the fourth terminal 60 can be identical to the first terminal 10, the fifth terminal 61 can be identical to the second terminal 11 and the sixth terminal 62 can be provided in addition to the third terminal 12. The fourth terminal 60 and the fifth terminal 61 can also be provided in addition to the first terminal 10 and the second terminal 12, and the third and sixth terminals 12, 62 can be identical.

FIG. 7 is a block diagram of one exemplary embodiment of an on-board electrical system 101 in a vehicle 100.

The on-board electrical system 101 has a traction battery 102 having a nominal voltage of for example 800 volts, a charging device 103 that is able to be connected to an electrical power supply system 104 external to the vehicle in order to charge or discharge the traction battery 102, and a control device 105 that is configured to provide the control information 20. The on-board electrical system 101 may be regarded as a high-voltage on-board electrical system, since its operating voltage is generally above 60 V.

The on-board electrical system 101 has a power converter 1 according to one of the exemplary embodiments described above, which is designed as an inverter. The power converter 1 is configured to supply electric power to an electric machine 106 of the on-board electrical system 101 by way of a polyphase AC voltage in order to drive the vehicle 100. The electric machine 106 is for example a permanently or electrically excited synchronous machine, an axial flux machine or an asynchronous machine.

The on-board electrical system 101 has a further power converter 1a according to the exemplary embodiment described above, which is designed as an active rectifier or as a DC/DC voltage converter and forms part of the charging device 103. The power converter 1a is configured to convert a DC or AC voltage provided by the electrical power supply system 104 external to the vehicle into a DC voltage for charging the traction battery 102.

The on-board electrical system 101 has a further power converter 1b according to the exemplary embodiment described above, designed as a DC/DC voltage converter. The power converter 1b is configured to couple the on-board electrical system 101 to a further on-board electrical system 107 of the vehicle 100. The further on-board electrical system 107 is for example a low-voltage on-board electrical system having an operating voltage of less than 60 volts, for example 12volts, 24 volts or 48 volts.

The control device 105 communicates with the charging device 103 via a signal line, symbolized by a double-headed arrow. The control device 105 is configured to provide the power converters 1, 1a, 1b with the control information 20 to adopt the second filter mode when and for as long as the charging device 103 is connected to the electrical power supply system 104 external to the vehicle. The second filter mode may thus be regarded in particular as a charging mode. By contrast, the control information 20 is provided to adopt the first filter mode in particular when the charging device 103 is disconnected from the electrical power supply system 104 external to the vehicle and when the vehicle 100 is driving. The first filter mode may therefore also be regarded as a driving mode.

The on-board electrical system 101 may furthermore have electrical conductors by way of which the third line 6 (see FIG. 1) of a respective power converter 1, 1a, 1b is electrically conductively connected to a vehicle body 108 of the vehicle 101, such that the reference potential 7 may also be regarded as a vehicle body potential. This is, at the same time, one of the potentials of the further on-board electrical system 107.

The vehicle 100 may accordingly be designed as a battery electric vehicle (BEV) or as a hybrid vehicle.

1. Power converter for an on-board electrical system of an electrically driveable vehicle having a first line for a first potential, a second line for a second potential, a third line for a reference potential and a filter device that has
a first terminal that is connected to the first line,
a second terminal that is connected to the second line,
a third terminal that is connected to the third line,
a first capacitor and a second capacitor, between which a central node is formed with an electrically conductive connection to the third terminal, and
a switching device that is configured to switch between a first filter mode and a second filter mode of the filter device on the basis of control information,
wherein
the filter device furthermore comprises
a third capacitor, which is connected between a terminal of the first capacitor facing away from the central node and the first terminal of the filter device, and
a fourth capacitor, which is connected between a terminal of the second capacitor facing away from the central node and the second terminal of the filter device,
wherein in the first filter mode
a first current path for an interference current is formed on the first line from the first terminal of the filter device via the third capacitor, a parallel connection of the first capacitor and the second capacitor and the central node to the third terminal of the filter device, and
a second current path for an interference current is formed on the second line from the second terminal of the filter device via the fourth capacitor, a parallel connection of the first capacitor and the second capacitor and the central node to the third terminal of the filter device,
wherein, in the second filter mode, an admittance for the interference currents along the first current path and the second current path is at least reduced compared to the first filter mode.

2. Power converter according to claim 1, wherein
the filter device is set up to set a higher pole frequency and/or a lower effective total capacitance for filtering the interference currents in the second filter mode between the first terminal and the third terminal and between the second terminal and the third terminal than in the first filter mode.

3. Power converter according to claim 1, wherein
in the second filter mode
the admittance along the first current path between the third capacitor and the second capacitor is at least reduced compared to the first filter mode and the admittance along the second current path between the fourth capacitor and the first capacitor is at least reduced compared to the first filter mode, or
the first current path in a circuit branch between the third capacitor and the second capacitor and the second current path in a circuit branch between the fourth capacitor and the first capacitor are interrupted.

4. Power converter according to claim 1, wherein
the central node is a common node
of the third terminal of the filter device,
a terminal of the first capacitor facing away from the third capacitor and/or facing the second capacitor, and
a terminal of the second capacitor facing away from the fourth capacitor and/or facing the first capacitor.

5. Power converter according to claim 1, wherein
the central node is connected to the third terminal of the filter device.

6. Power converter according to claim 1, wherein
the switching device has a first terminal and a second terminal and a switching path able to be controlled on the basis of the control information.

7. Power converter according to claim 6, wherein
the first terminal of the switching device has a common node with the first capacitor and the third capacitor and/or the second terminal of the switching device has a common node with the second capacitor and the fourth capacitor.

8. Power converter according to claim 6, wherein
the switching device is configured to switch on the switching path so as to adopt the first filter mode and/or to switch it off so as to adopt the second filter mode.

9. Power converter according to claim 1, wherein
the capacitances of the first capacitor and of the fourth capacitor are smaller or larger, in particular by a factor of at least two, in particular by a factor of at least five, than the capacitances of the second capacitor and the third capacitor.

10. Power converter according to claim 1, wherein
the capacitances of the first capacitor and the fourth capacitor are equal and/or the capacitances of the second capacitor and the third capacitor are equal.

11. Power converter according to claim 1, wherein
the filter device further has a fifth capacitor which is connected to the first terminal and to the second terminal of the filter device in parallel with the first to fourth capacitors and, in particular, has a capacitance larger, in particular at least by a factor of five, preferably a factor of ten, than the largest capacitance of the first to fourth capacitor.

12. Power converter according to claim 1, wherein
a fourth terminal of the filter device is the first terminal of the filter device or is connected to the first line, wherein
a fifth terminal of the filter device is the second terminal of the filter device or is connected to the second line, wherein
a sixth terminal of the filter device is the third terminal of the filter device or is connected to the third line, wherein
the filter device furthermore has
a sixth capacitor and a seventh capacitor, between which a second central node is formed with an electrically conductive connection to the sixth terminal,
an eighth capacitor, which is connected between a terminal of the sixth capacitor facing away from the second central node and the fourth terminal of the filter device,
a ninth capacitor, which is connected between a terminal of the seventh capacitor facing away from the second central node and the fifth terminal of the filter device, and
a second switching device that is configured to switch between a first filter mode and a second filter mode of the filter device depending on control information,
wherein
a third current path for the interference current is formed on the first line from the fourth terminal of the filter device via the eighth capacitor, a parallel connection of the sixth capacitor and the seventh capacitor and the second central node to the sixth terminal of the filter device, wherein
a fourth current path for the interference current is formed on the second line from the fifth terminal of the filter device via the ninth capacitor, a parallel connection of the sixth capacitor and the seventh capacitor and the second central node to the sixth terminal of the filter device, wherein
in the second filter mode, an admittance for the interference currents along the third current path and the fourth current path is at least reduced compared to the first filter mode.

13. Power converter according to claim 12, wherein
the capacitances of the sixth capacitor and of the ninth capacitor are greater, in particular by at least a factor of two, in particular by at least a factor of five, than the capacitances of the seventh capacitor and of the eighth capacitor, if the capacitances of the first capacitor and of the fourth capacitor are smaller than the capacitances of the second capacitor and of the third capacitor, or
the capacitances of the sixth capacitor and of the ninth capacitor are smaller, in particular by at least a factor of two, in particular by at least a factor of five, than the capacitances of the seventh capacitor and of the eighth capacitor, if the capacitances of the first capacitor and of the fourth capacitor are greater than the capacitances of the second capacitor and of the third capacitor.

14. Power converter according to claim 1, wherein
the filter device has a printed circuit board, wherein
the first to fourth capacitors in particular also the fifth capacitor and/or the sixth to ninth capacitors are arranged on the printed circuit board and/or
the first to third terminals of the filter device are arranged on the printed circuit board and/or
the switching device or the switching devices is arranged on the printed circuit board,
and/or
the power converter further comprises a DC link capacitor which is connected between the first line and the second line and in particular has a capacitance which is greater by at least a factor of one hundred, preferably a factor of five hundred, than the largest capacitance of the first to fourth capacitor, and a converter circuit, which is connected between the first line and the second line, wherein the filter device is arranged on the side of the DC link capacitor facing away from the converter circuit.

15. On-board electrical system for an electrically driveable vehicle, having
at least one power converter according to claim 1, a traction battery, a charging device that is able to be connected to an electrical power supply system external to the vehicle in order to charge or discharge the traction battery, and a control device that is configured to provide the control information to adopt the second filter mode when and/or for as long as the charging device is connected to the electrical power supply system external to the vehicle.

16. Power converter according to claim 2, wherein
in the second filter mode
the admittance along the first current path between the third capacitor and the second capacitor is at least reduced compared to the first filter mode and the admittance along the second current path between the fourth capacitor and the first capacitor is at least reduced compared to the first filter mode, or
the first current path in a circuit branch between the third capacitor and the second capacitor and the second current path in a circuit branch between the fourth capacitor and the first capacitor are interrupted.

17. Power converter according to claim 2, wherein
the central node is a common node
of the third terminal of the filter device,
a terminal of the first capacitor facing away from the third capacitor and/or facing the second capacitor, and
a terminal of the second capacitor facing away from the fourth capacitor and/or facing the first capacitor.

18. Power converter according to claim 2, wherein
the central node is connected to the third terminal of the filter device.

19. Power converter according to claim 2, wherein
the switching device has a first terminal and a second terminal and a switching path able to be controlled on the basis of the control information.

20. Power converter according to claim 7, wherein
the switching device is configured to switch on the switching path so as to adopt the first filter mode and/or to switch it off so as to adopt the second filter mode.
